(19) United States
(12) Patent Application Publication
(10) Pub. No.: US 2009/0123127 A1
(43) Pub. Date: May 14, 2009

(54) SCHEDULED RECORDING APPARATUS AND METHOD FOR SETTING SCHEDULED RECORDING

(76) Inventor: Yasuhiro MORIOKA, Kawasaki-shi (JP)

Correspondence Address: FINNEGAN, HENDERSON, FARABOW, GARRETT & DUNNER;LLP, 901 NEW YORK AVENUE, NW, WASHINGTON, DC, 20001-4413, US

(21) Appl. No.: 12/191,840

(22) Filed: Aug. 14, 2008

(30) Foreign Application Priority Data
Nov. 12, 2007 (JP) P.2007-293553

(51) Int. Cl. H04N 5/91

(52) U.S. Cl. 386/83

(57) ABSTRACT

An apparatus has a recording execution section for recording a target of presetting; a preset target designation section for designating a target of presetting; a content management section that stores contents recorded in the past and record settings of the recorded contents; a record setting candidate listing section that, when the degree of similarity between information about the target of presetting and information about recorded contents is equal to or larger than a threshold value, extracts from storage unit the record settings of the recorded contents as candidates for record settings by reference to the content management section; and a record setting designation section that displays the thus-extracted candidates for record settings and that designates record settings.

### CROSS-REFERENCE TO RELATED APPLICATIONS

This application is based upon and claims the benefit of priority from Japanese Patent Application No. 2007-293553, filed on Nov. 12, 2007, the entire content of which are incorporated herein by reference.

### BACKGROUND

1. Field

One embodiment of the invention relates to a scheduled recording apparatus and a method for setting a scheduled recording, which display candidates for a record setting.

2. Description of the Related Art

Opportunities to record TV broadcast programs by means of an apparatus having a function of playing back and recording video and audio, such as a video cassette recorder, an HDD recorder (a video recorder having a built-in HDD (Hard Disk Drive)), and a DVD recorder (a video recorder having a function of recording digital data on a DVD (Digital Versatile Disc)) and to enjoy the thus-recorded programs later become larger. When a scheduled recording instruction is input to a recorder, channel information showing a subject of recording, a broadcast time and date, or program information, such as a program identifier, as well as a record setting showing specifics of recording operation, such as recording quality or a destination of recording, are required. The record setting is not determined directly from program information pertaining to a program that is designated to be schedule recorded. When setting a scheduled recording, a user selects a value of a record setting, or a default value set for each recorder is designated as a record setting.

A viewing situation for viewing recorded contents can vary from one user to another. It is highly possible that there arises a case where the user records a favorite program at high quality and records a non-favorite program at low quality. Moreover, when there are many occasions of the programs being not viewed by means of the recorder, recorded information being written into an external storage medium and carried out from the recorder, and the information being utilized by means of an external viewing device (for example, a portable content player device), settings conforming to requirements must be made. It is very laborious for the user to designate all of the settings. In most cases, the user performs re-setting operation by utilization of previously-prepared default values, as required, to thus make settings. However, the default values cannot be said to reflect user's handling of contents that are a program to be subjected to scheduled recording (hereinafter called a “scheduled-recording target program”). Making detailed settings still entails troublesome operation.

Therefore, in relation to such a video recorder, attempts have been made to enhance user's convenience during recording operation. For example, in JP-A-2005-302245, there is disclosed a technique to check whether or not user's viewing history information about recorded programs and a keyword previously input or designated by the user are present in program information about recorded programs, thereby calculating the degree of user's interest about each of keywords. An apparatus described in JP-A-2005-302245 predicts, from resultant information and a result of search of a keyword in program information serving as an object of automatic recording, the degree of user's preference in a program to be automatically recorded. The apparatus described in JP-A-2005-302245 automatically determines, from the degree of preference, recording quality for automatic recording operation.

However, according to the conventional technique, recording quality set for automatic recording operation is weighted in accordance with the predicted degree of user's preference. Settings are no more than made higher as the degree of preference becomes larger. Therefore, according to such a technique, automatic settings reflecting programs of different genres are not always made. Therefore, a technique that enables recording operation reflecting, to a much larger extent, programs to be subjected to scheduled recording has been desired.

### SUMMARY

One of objects of the present invention is to provide a scheduled recording apparatus and a method for setting a scheduled recording that enable the user to set a record setting based on specifics of a scheduled-recording target program without involvement of laborious operation for the record setting when setting the scheduled recording of the program.

According to a first aspect of the present invention, there is provided a scheduled recording apparatus including: a recording unit that records a video in accordance with a preset record setting; a storage unit that stores content information and record settings, the content information indicating contents recorded in the past by the recording unit, the record settings being set for each of the recorded contents; a target program designation unit that designates a scheduled-recording target program to be subjected to a scheduled recording; a candidate listing unit that, when a degree of similarity between program information pertaining to the scheduled-recording target program designated by the target program designation unit and content information pertaining to the recorded contents is equal to or larger than a threshold value, extracts from the storage unit the record settings as candidates of a target record setting to be used in recording the scheduled-recording target program; and a scheduled recording designation unit that selects the target record setting from among the candidates extracted by the candidate listing unit.

According to a second aspect of the present invention, there is provided a method for setting a scheduled recording in a scheduled recording apparatus, the method including: recording a video in accordance with a preset record setting; storing content information and record settings, the content information indicating contents recorded in the past by the recording unit, the record settings being set for each of the recorded contents; designating a scheduled-recording target program to be subjected to a scheduled recording; extracting, when a degree of similarity between program information pertaining to the designated scheduled recording target program and content information pertaining to the recorded contents is equal to or larger than a threshold value, from the stored record settings as candidates of a target record setting to be used in recording the scheduled recording target program; and selecting the target record setting from among the extracted candidates.

### BRIEF DESCRIPTION OF THE SEVERAL VIEWS OF THE DRAWINGS

A general configuration that implements the various feature of the invention will now be described with reference to the drawings. The drawings and the associated descriptions are provided to illustrate embodiments of the invention and not to limit the scope of the invention.

FIG. 1 is a block diagram showing a configuration of hardware of a scheduled recording apparatus according to a first embodiment of the present invention.

FIG. 2 is a block diagram showing a configuration of software for the scheduled recording apparatus according to the first embodiment.

FIG. 3 is a view showing an example of a user operation screen for preparing scheduled recording.

FIG. 4 is a flowchart showing general procedures for preparing scheduled recording in the scheduled recording apparatus according to the first embodiment.

FIG. 5 is a flowchart showing details of a procedure in S1 of FIG. 4 for designating a scheduled recording target program.

FIG. 6 is a flowchart showing details of a procedure in S2 of FIG. 4 for designating a record setting.

FIG. 7 is a view showing an example portion of an operation screen for prompting a user to set recording quality in the related art.

FIG. 8 is a view showing an example portion of an operation screen for prompting the user to set recording quality in the present embodiment.

FIG. 9 is a view showing an example portion of an operation screen for prompting the user to set recording quality in the present embodiment.

FIG. 10 is a flowchart showing details of a procedure in B2 of FIG. 6 for listing candidates for record settings.

FIG. 11 is a view showing an example table of a rule for calculating the degree of similarity in the embodiment.

FIG. 12 is a view showing an example extraction of a record setting from scheduled recording information analogous to information about a target of the scheduled recording.

FIG. 13 is a block diagram showing a configuration of hardware of a scheduled recording apparatus according to a second embodiment of the present invention.

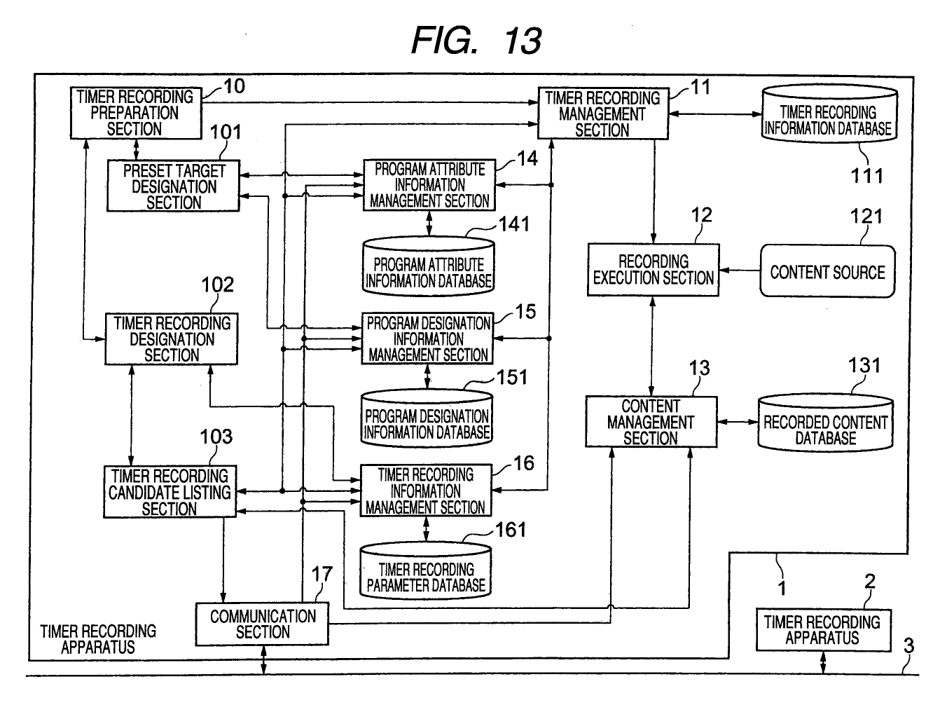

FIG. 14 is a flowchart showing details on a procedure in S2 of FIG. 4 for designating a record setting according to the second embodiment.

### DETAILED DESCRIPTION

Referring now to the accompanying drawings, there are shown preferred embodiments of the present invention. In the following description, identical components or components having identical functions are denoted by the same reference numerals to omit redundant description therefor.

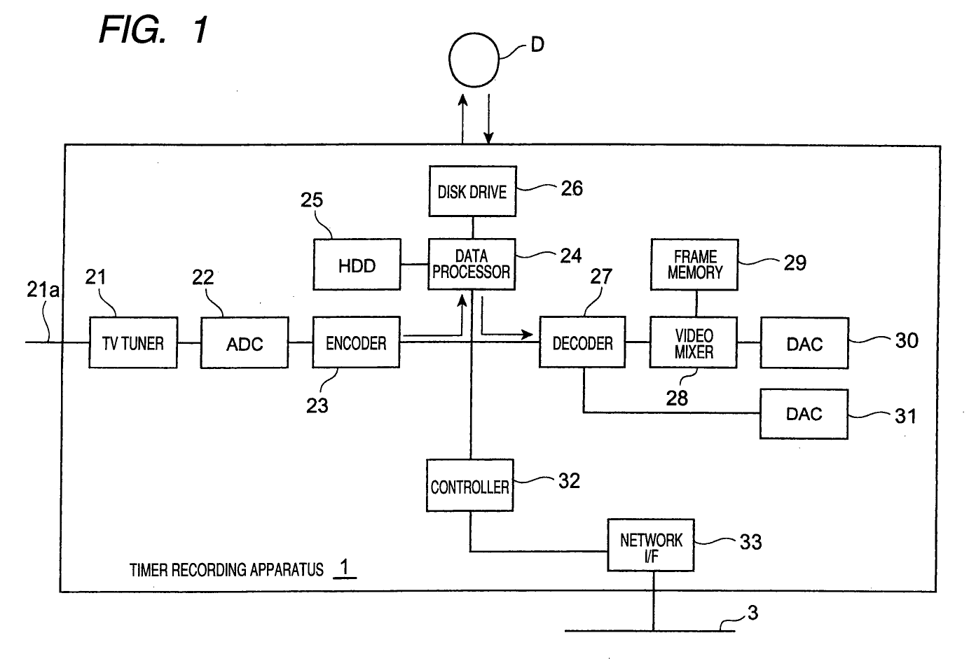

FIG. 1 is a block diagram showing the configuration of hardware of a scheduled recording apparatus 1 according to a first embodiment of the present invention. As shown in FIG. 1, a broadcast signal received by an unillustrated antenna is input to a TV tuner 21 through an antenna line 21a. The TV tuner 21 subjects the input signal to demodulation, or the like, and outputs an analogue video signal. An ADC (Analogue-to-Digital Converter) 22 quantizes the analogue video signal; for example, at a sampling frequency of 13.5 MHz and into eight quantization bits. Likewise, the ADC 22 quantizes an analogue audio signal; for example, at a sampling frequency of 48 kHz and into 16 quantization bits.

The digital video signal and the digital audio signal output from the ADC 22 are input to an encoder 23. The encoder 23 compresses the input digital video signal in accordance with MPEG-2 standards; converts the signal into a compressed digital video signal; and outputs the thus-compressed digital video signal. The encoder also compresses the digital audio signal in accordance with; for example, AC (Audio Compression)-3 standards; converts the signal into a compressed digital audio signal; and outputs the thus-compressed digital audio signal.

The encoder 23 subjects the compressed digital video signal and the compressed digital audio signal to signal processing so as to assume a format suitable for recording, and outputs the thus-processed signals to a data processor 24. Information encoded by the encoder 23 and management information produced by a controller 32 are recorded in an HDD 25 or an optical disk D, such as DVD-RAM, inserted in a DVD drive 26, by way of the data processor 24 (record data for playing back a video are recorded in the HDD 25 or the optical disk D), which serve as storage unit.

The signal recorded in the HDD 25 or the optical disk D inserted into the DVD drive 26 is output to a decoder 27 by way of the data processor 24. The decoder 27 has a function of separating the video signal and the audio signal from the input signal and decoding the respective signals. The video signal output from the decoder 27 is input to a video mixer 28. While using frame memory 29 as buffer, the video mixer 28 merges the input video signal, text data, and image data. After being converted into an analogue signal by means of a DAC (Digital-to-Analogue Converter) 30, the video mixer 28 outputs the analogue signal to an external device. Likewise, after being converted into an analogue signal by means of the DAC 31, the decoder 27 outputs the audio signal to an external device.

The controller 32 has an MPU (Micro Processing Unit), ROM, and RAM. A control program and a program executed by the MPU are written in the ROM. The RAM is arranged so as to be able to provide a work area required for the MPU to execute the program. The controller 32 controls the respective modules in accordance with the control program stored in the ROM and exercise control over setting operation, such as recording and playback. Further, the controller 32 receives, by way of an unillustrated infrared-radiation receiver, information about operation of an unillustrated remote controller to be operated by a user and controls operation in accordance with received information. Further, the controller 32 controls operation of a network interface (network I/F) 33 that establishes communication with another device connected to a network 3. Moreover, the controller 32 provides a library management function.

The controller 32 is used for recording operation performed by the HDD 25 or the DVD drive 26. Based on information previously set prior to recording operation, the controller 32 controls performance of scheduled recording operation. The controller 32 stores the information set prior to recording into the ROM or RAM (or the HDD).

The controller 32 monitors a current time and performs recording operation when a recording start time comes. When the recording start time comes, the controller 32 selects a channel designated by a channel number of the information and controls the encoder 23 in accordance with a recording mode, thereby performing recording operation. Further, the controller 32 monitors a current time during performance of recording operation. When a recording stop time comes, the controller stops the recording operation and saves a signal recorded through the recording operation (i.e., a video signal and an audio signal).

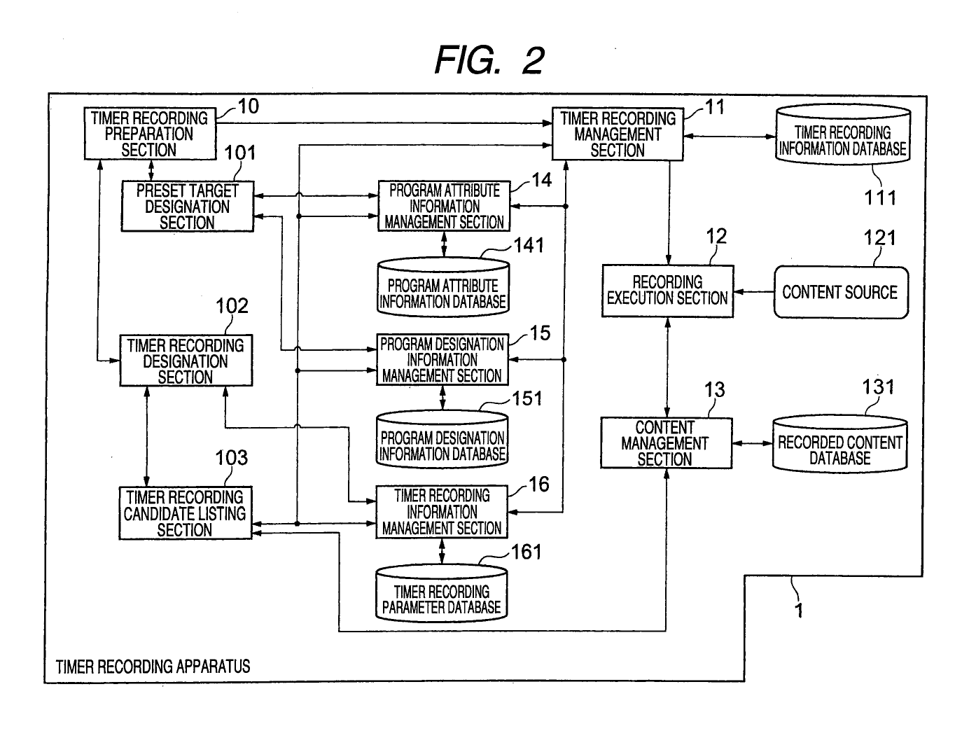

FIG. 2 is a block diagram showing a configuration of software for the scheduled recording apparatus 1 according to the first embodiment of the present invention. As shown in FIG. 2, the scheduled recording apparatus 1 of the present embodiment has a scheduled recording preparation section 10 that, in accordance with a user's input, generates scheduled recording information including a record setting and program designation information, such as a channel of a scheduled recording target program, a recording time and date, and a recording hour and that demands preparation of scheduled recording; a preset target designation section 101 that designates a scheduled recording target program based on an input from the user; a record setting designation section 102 that designates a record setting on a scheduled recording target program; and a record setting candidate listing section 103 that generates candidates for record setting who are candidates for a record setting corresponding to the scheduled recording target program.

The scheduled recording apparatus 1 has a scheduled recording management section 11 that retains scheduled recording information and that performs browsing, making of a response in answer to a search request, and addition, deletion, and updating operations; a recording execution section 12 that records a scheduled recording target program at a record setting based on the scheduled recording information in connection with a program that pertains to the scheduled recording information held in the scheduled recording management section 11 and for which a recording start time has come; and a content management section 13 that retains contents recorded by the recording execution section 12 in the past and that performs browsing, making of a response in answer to a search request, and addition, deletion, and updating operations.

Further, the scheduled recording apparatus 1 has a program attribute information management section 14 that retains program attribute information, which is an element constituting program information about a scheduled recording target program and which describes specifics of a program, such as the title of a program, a genre, and the cast, and that responds to a browsing or search request; a program designation information management section 15 that retains a value range pertaining to a channel, a recording start time and date, and a recording hour, and restriction information, which are elements constituting the program information about a scheduled recording target program, and that answers a browsing or search request; and a record setting information management section 16 that retains a value range and restriction information regarding settings pertaining to recording quality, a destination of recording, and other recording operations which are elements constituting a record setting of a scheduled recording target program and that responds to a browsing or search request.

Each of the scheduled recording management section 11, the content management section 13, the program attribute information management section 14, the program designation information management section 15, and the record setting information management section 16 has a scheduled recording information database 111 for storing scheduled recording information; a record content database 131 that stores recorded contents, content information about recorded contents, record settings of the recorded contents, and the like; a program attribute information database 141 storing program attribute information; a program designation information database 151 that stores program designation information made up of a value range and restriction information regarding a scheduled recording target program, such as a channel of a scheduled recording target program; and a record setting parameter database 161 storing restriction information about a record setting. The recording execution section 12 has means for selecting and receiving an external content source 121.

The scheduled recording preparation section 10 accepts an input from the user, to thus constitute recording preset information, and requests the scheduled recording management section 11 to prepare scheduled recording from the constituted recording preset information. When accepting the input from the user to constitute recording preset information, the scheduled recording preparation section 10 instructs the preset target designation section 101 to designate a scheduled recording target program which is to serve as a target of scheduled recording or program designation information showing a combination of a channel pertaining to a scheduled recording target program, a recording hour, and the like, as well as instructing the record setting designation section 102 to designate a record setting for specifying recording quality, a destination of recording, and the like.

The preset target designation section 101 acquires, from the program designation information management section 15, a value range and restrictions pertaining to a channel, a recording start time and date, and a recording hour that can be designated in connection with a scheduled recording target program; selects a combination conforming to a user's request from combinations; and returns the thus-selected combination to the scheduled recording preparation section 10. The preset target designation section 101 acquires, from the program attribute information management section 14, a list of pieces of program attribute information that can be designated in connection with the scheduled recording target program; selects program attribute information conforming to the user's request; and returns the thus-selected information to the scheduled recording preparation section 10.

In accordance with program information that is information pertaining to a scheduled recording target program designated by the preset target designation section 101, the record setting designation section 102 acquires, from the record setting information management section 16, a value range and restrictions for settings pertaining to recording quality, a destination of recording, and recording of another scheduled recording target program that can be designated as a record setting; selects a combination conforming to the user's request from combinations of scheduled recording candidates corresponding to the scheduled recording target program returned from the record setting candidate listing section 103; and returns the selected combination to the scheduled recording preparation section 10.

The record setting candidate listing section 103 acquires, from the past scheduled recording information stored in the scheduled recording information database 111 and content information pertaining to recorded contents stored in the recorded content database 131, a record setting pertaining to program information analogous to that pertaining to a scheduled recording target program. The record setting candidate listing section 103 acquires, from the program attribute information management section 14, corresponding program attribute information based on the program designation information designated by the preset target designation section 101; and acquires, from the scheduled recording management section 11, a record setting associated with scheduled recording information highly analogous to the program attribute information and the program designation information. Further, the record setting candidate listing section 103 acquires, from the content management section 13, a record setting associated with content information about a recorded content that is highly analogous to the program attribute information and program designation information; and returns the thus-acquired record setting as a scheduled recording candidate.

The program attribute information management section 14 stores information that can be designated as program attribute information into a program attribute information database 141, and returns the information in response to a request for reference from another functional element. The program attribute information includes attribute information for describing specifics of a program, such as the title of a program, a genre, and the cast.

The program designation information management section 15 stores, in a record setting parameter database 161, information about: an identifier of a program that can be designated as program designation information; a value range and restrictions for a channel, a recording start time and date, and a broadcasting time. The program designation information management section 7 returns the information in answer to a request for reference from another functional element.

The record setting information management section 16 stores, in a record setting parameter database 161, information about a specifiable value range and restrictions for settings pertaining to recording of a program that can be designated as a record setting, such as a recording quality setting and a record destination setting. The record setting information management section 16 returns the information in answer to a request for reference from another functional element.

The scheduled recording management section 11 accepts a request for preparation of scheduled recording from the scheduled recording preparation section. When being able to accept an addition, the scheduled recording management section 11 adds new scheduled recording information to the scheduled recording information database 111.

In relation to a scheduled recording target program whose recording start time has come among the pieces of scheduled recording information held in the scheduled recording management section 11, the recording execution section 12 performs recording based on the record setting in the scheduled recording information about the program. Recorded contents and content information about contents are stored in the recorded content database 131 by means of the content management section 13.

The content management section 13 retains, in the recorded content database 131, content information about the recorded contents, to thus update the database; and responds to an information request for recorded contents from another constituent element. The content information about recorded contents includes program designation information showing an identifier, a channel, a broadcasting date, and a broadcasting time of a program and program attribute information serving as attribute information for describing specifics of a program, such as the title of a program, a genre, and the cast. Record settings of recorded contents are recorded in the content database 131.

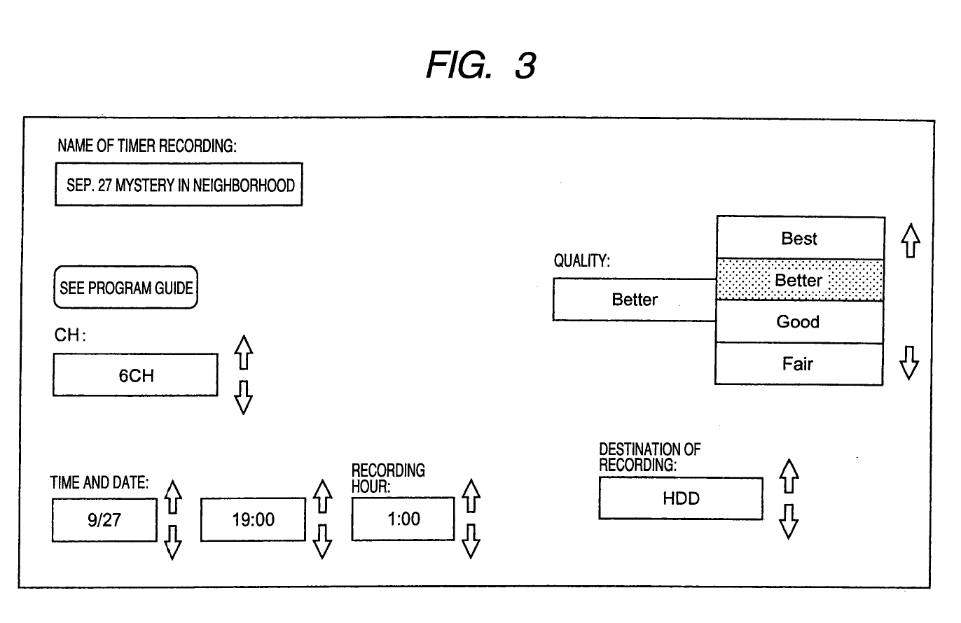

The scheduled recording preparation section 10 provides the user with an operation screen, as well as providing means for designating a scheduled recording target program by means of the preset target designation section 101 and means for designating a record setting by means of the record setting designation section 102. FIG. 3 shows an example user operation screen acquired at the time of preparation of scheduled recording. A left half of the screen is an operation screen pertaining to designation of a scheduled recording target program, and a right half of the screen is an operation screen pertaining to designation of a record setting.

In the example shown in FIG. 3, the title of a program to be subjected to scheduled recording, a channel, a recording start time, a recording hour, recording quality, and a destination of recording can be selectively designated. Further, the channel, the recording start time, and the recording time can be designated directly but designated by reference to a program guide, as well. As illustrated in a display regarding recording quality provided in FIG. 3, some of the items to be designated are selectively designated from some value ranges. In relation to information about a possible value range and restrictions, program designation information and information about items of a record setting are acquired from the program designation information management section 15 and the record setting information management section 16, whereby the user operation screen can be configured such that only appropriate values can be designated.

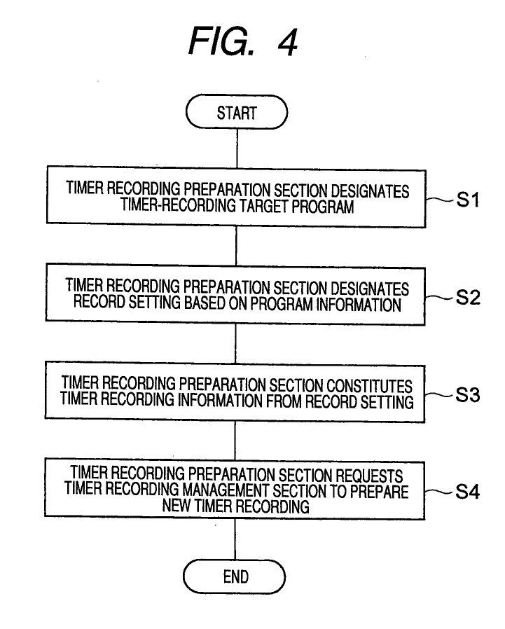

Procedures from acquisition of required information until preparation of scheduled recording are described below. As shown in FIG. 4, S1 through S4 described below are general procedures for preparing scheduled recording.

In step S1, the scheduled recording preparation section 10 designates a scheduled recording target program.

In step S2, the scheduled recording preparation section 10 designates a record setting based on program information.

In step S3, the scheduled recording preparation section 10 constitutes scheduled recording information from the program information and the record setting.

In step S4, the scheduled recording preparation section 10 requests the scheduled recording management section 11 to prepare new scheduled recording.

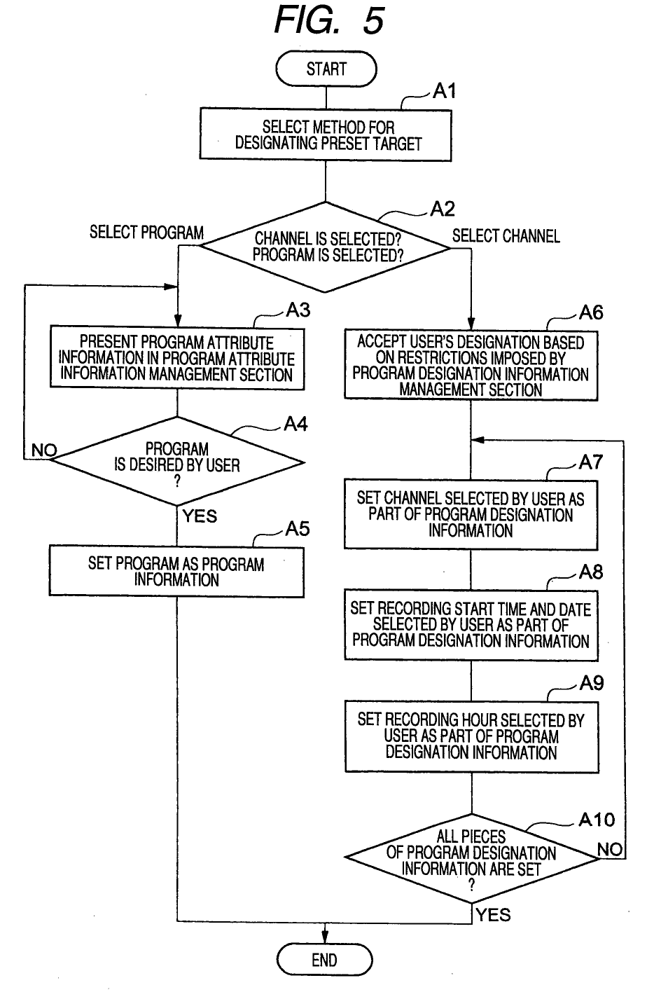

Details of S1 and S2 will now be described. FIG. 5 is a flowchart showing in detail a procedure in S1 of FIG. 4 for designating a scheduled recording target program. As shown in FIG. 5, the procedure for designating the scheduled recording target program includes A1 to A10 described below.

The preset target designation section 101 accepts a user input as to whether to designate a scheduled recording target program from a program guide or directly designate a channel, a recording start time and date, and a recording hour (A1). When the user designates a scheduled recording target program from the program guide, the preset target designation section 101 proceeds to A3 (A2). When the user directly designates a channel, a recording start time and date, and a recording hour, the preset target designation section 101 shifts to A6 (A2).

The preset target designation section 101 acquires one or more pieces of program attribute information from the program attribute information management section 14 and presents the thus-acquired information to the user (A3). When the user selects a desired program, the preset target designation section 101 proceeds to A5 (A4); otherwise, the preset target designation section 101 will return to A3 (A4). The preset target designation section 101 designates, as program information, the selected program attribute information or program designation information, such as a program identifier, and processing ends (A5).

The preset target designation section 101 acquires, from the program designation information management section 15, restriction information about a channel, a recording start time and date, and a recording hour and accepts a designation made by the user (A6). The restriction information includes any one or some of a list of specifiable channels, the range of specifiable recording times and dates, and the range of specifiable recording hours. A6 includes a procedure for the preset target designation section 101 generating, from the restriction information, an operation screen by means of which the user designates a scheduled recording target program.

The preset target designation section 101 sets the channel selected by the user as a portion of the program designation information (A7). The preset target designation section 101 sets the recording start time selected by the user as a portion of the program designation information (A8). The preset target designation section 101 sets the recording hour set by the user as a portion of the program designation information (A9). When all of the portions of the program designation information are set, the preset target designation section 101 terminates processing (A10); otherwise, the preset target designation section 101 will return to A7 (A10).

A1 through A10 set forth are example procedures for designating program information. For example, in A1 through A10, the preset target designation section 101 may also return to any of A1, A3, and A6 and again perform designation. The preset target designation section 101 may also perform processing pertaining to A7 and A8 in an arbitrary sequence.

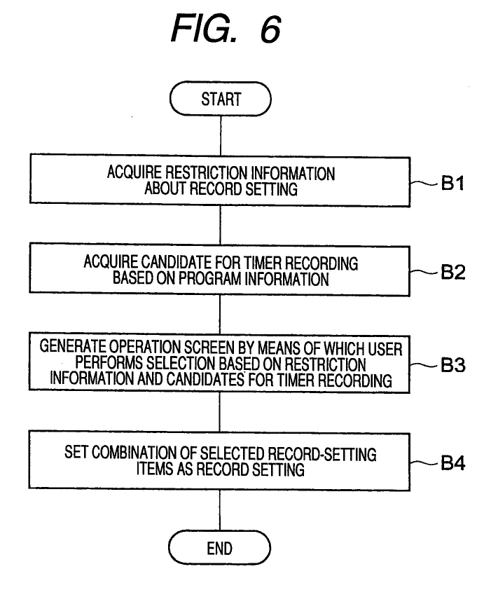

FIG. 6 is a flowchart showing details on a procedure in S2 of FIG. 4 for designating a record setting. As shown in FIG. 6, the procedure in S2 for designating a record setting includes B1 through B4.

The record setting designation section 102 acquires, from the record setting information management section 16, restriction information about a record setting (B1). The record setting designation section 102 acquires, from the record setting candidate listing section 103, candidates for record settings based on the program information (B2). The record setting designation section 102 generates, from the restriction information and the candidates for record settings, an operation screen for accepting selection made by the user (B3). The record setting designation section 102 sets a combination of scheduled recording items selected by the user as a record setting (B4).

There is included a procedure for, on the occasion when the selection made by the user is accepted in S3, the record setting designation section 102 processing the restriction information based on the candidates for record settings, to thus generate an operation screen by means of which the user designates a record setting, and the like.

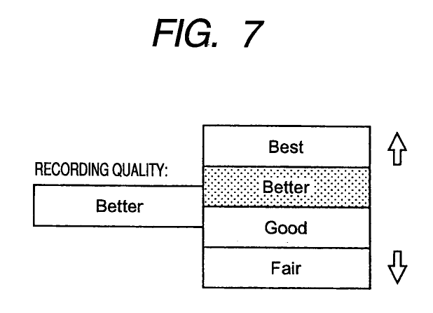

FIG. 7 shows an example portion of an operation screen for prompting the user to set recording quality in the related-art scheduled recording apparatus. FIG. 7 shows that restrictions on recording quality have four levels of values; namely, Fair, Good, Better, and Best; that a default value is Better; and that recording quality can be selected by means of vertical movement of a cursor and a determination operation.

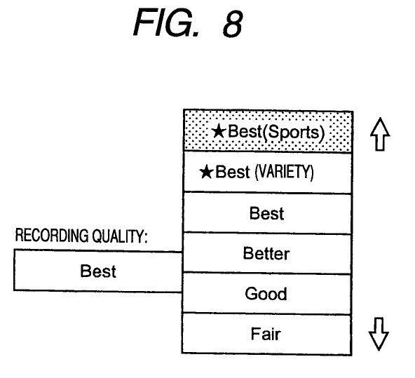

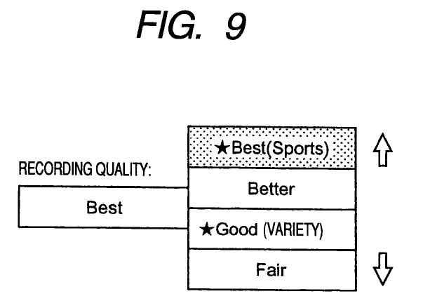

FIGS. 8 and 9 show an example portion of the operation screen on the scheduled recording apparatus 1 of the present embodiment, wherein the record setting designation section 102 prompts the user to set recording quality based on the scheduled recording items acquired from the record setting information management section 16. As a result of the candidates for record settings based on the program information being acquired, the record setting designation section 102 displays, for options, Best and Good as candidates for record settings along with an option not based on the program information, as shown in FIG. 8, showing by means of asterisks that the options are examples of the candidates for settings. The record setting designation section 102 displays, in an enhanced manner, candidates for record settings conforming to Best and Good among the options by means of asterisks as shown in FIG. 9. The options may also be presented for the user while one of the candidates for record settings; namely, “Best” in this case, is selected in advance. In this case, as shown in FIG. 9, the record setting designation section 102 may add to the display of the options information plainly showing a reason that the options are set as candidates for settings; namely, “Sport” or “Variety.”

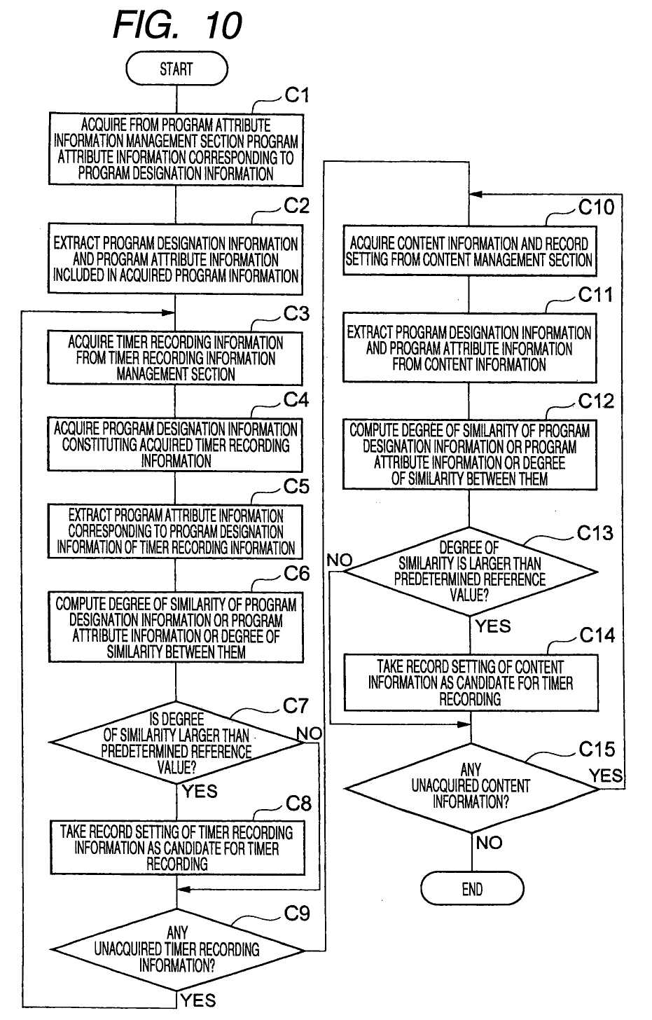

FIG. 10 is a flowchart showing details of a procedure in B2 of FIG. 6 for listing candidates for record settings. As shown in FIG. 10, the procedure B2 for listing the candidates for record settings are C1 through C15 described below.

When the user designated the channel, the recording start time and date, and the recording hour in A2, the record setting candidate listing section 103 acquires, from the program attribute information management section 14, program attribute information corresponding to the program designation information (C1). The record setting candidate listing section 103 extracts the program designation information and the program attribute information included in the program information acquired in A1 through A10 and C1 (C2).

In C3 through C9 described below, the record setting candidate listing section 103 extracts, from the past scheduled recording information stored in the scheduled recording information database 111, a record setting analogous to the program information about the scheduled recording target program. The record setting candidate listing section 103 acquires scheduled recording information from the scheduled recording management section 11 (C3). The record setting candidate listing section 103 acquires program designation information constituting the acquired scheduled recording information (C4). The record setting candidate listing section 103 acquires, from the program attribute information management section 14, program attribute information corresponding to program designation information of the scheduled recording information, thereby extracting the program attribute information (C5). The record setting candidate listing section 103 calculates the degree of similarity of either the program designation information or the program attribute information or the degree of similarity of both of them in connection with the program information about the scheduled recording target program and program information of the scheduled recording information (C6).

When either the program designation information or the program attribute information or both of them, in relation to the program information about the scheduled recording target program and the program information of the scheduled recording information, exhibit the degree of similarity that is larger than a predetermined reference value, the record setting candidate listing section 103 proceeds to C8; otherwise, the record setting candidate listing section 103 will proceed to C9 (C7). The record setting candidate listing section 103 adds the record setting in the scheduled recording information to the candidates for record settings (C8). When there is an unacquired piece of scheduled recording information, the record setting candidate listing section 103 proceeds to step C3; otherwise, the record setting candidate listing section 103 will proceed to C10 (C9).

In C10 to C15 described below, the record setting candidate listing section 103 extracts record settings of contents analogous to the program information about the scheduled recording target program among the content information about the recorded contents stored in the recorded content database 131. The record setting candidate listing section 103 acquires, from the content management section 13, content information including content designation information and content attribute information about the recorded contents and record settings of the recorded contents (C10). The record setting candidate listing section 103 extracts, from the content information, program designation information and program attribute information or portions thereof (C11). The record setting candidate listing section 103 calculates the degree of similarity of either the program designation information or the program attribute information or both of them, in relation to the program information about the scheduled recording target program and the content information (C12).

When the degree of similarity is larger than a predetermined reference value, the record setting candidate listing section 103 proceeds to C14; otherwise, the record setting candidate listing section 103 will proceed to C15 (C13). The record setting candidate listing section 103 adds a record setting of the content information to the candidates for record settings (C14). When there are unacquired pieces of content information, the record setting candidate listing section 103 proceeds to C10; otherwise, the record setting candidate listing section 103 will complete processing (C15).

In relation to a method for listing the scheduled recording information and the content information, either of them or a list of them may also be listed. Alternatively, search results may also be listed in connection with pieces of information whose values match with values of the program designation information and the program attribute information, which are preset by the user that the user is interested in. For example, in relation to the genre of the scheduled recording target program, search results may also be listed with regard to pieces of information whose genres match with a genre included in the program attribute information of the program information about the scheduled recording target program and a genre included in the program attribute information of the scheduled recording information and the content information.

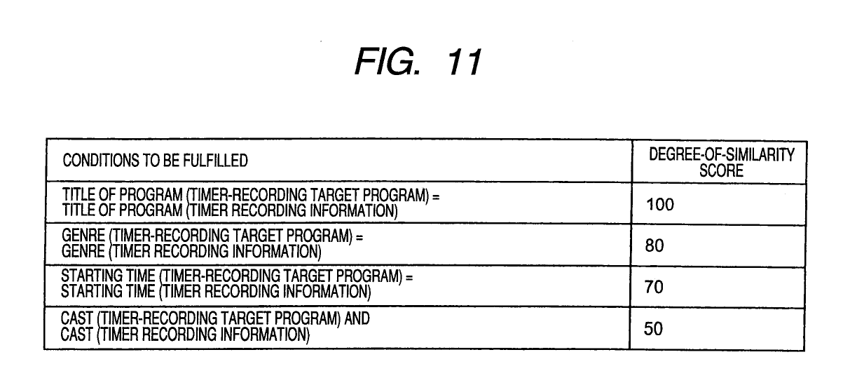

Under the method for calculating the degree of similarity of the embodiment, a score achieved when a match with a predetermined rule is found is taken as the degree of similarity. In an example table of a rule shown in FIG. 11 for calculating the degree of similarity between program information about a scheduled recording target program and scheduled recording information, from above when a match exists between the pieces of information in terms of the title of a program, the degree of similarity is assumed to be defined as 100; when a match exists between the pieces of information in terms of genres, the degree of similarity is assumed to be defined as 90; when a match exists between the pieces of information in terms of a channel, a day of the week, or a starting time, the degree of similarity is assumed to be defined as 70; and, when a match exists between the pieces of information in terms of some of the cast, the degree of similarity is assumed to be defined as 50. In the following embodiment, the rule is handled as being given and unchanging. However, the specifics of the rule may also be updated in accordance with setting operation performed by the user or based on analysis of the record settings of the scheduled recording information and the content information.

The method for calculating the degree of similarity described herein is an example. The highest values of respective items may also be taken as the degree of similarity, or a total of scores of respective items involving matches may also be taken as the degree of similarity. In the present embodiment, the degree of similarity is computed by comparison between the scheduled recording information and the content information. However, the degree of similarity may also be determined in connection with a characteristic common to a plurality of pieces of scheduled recording information and content information.

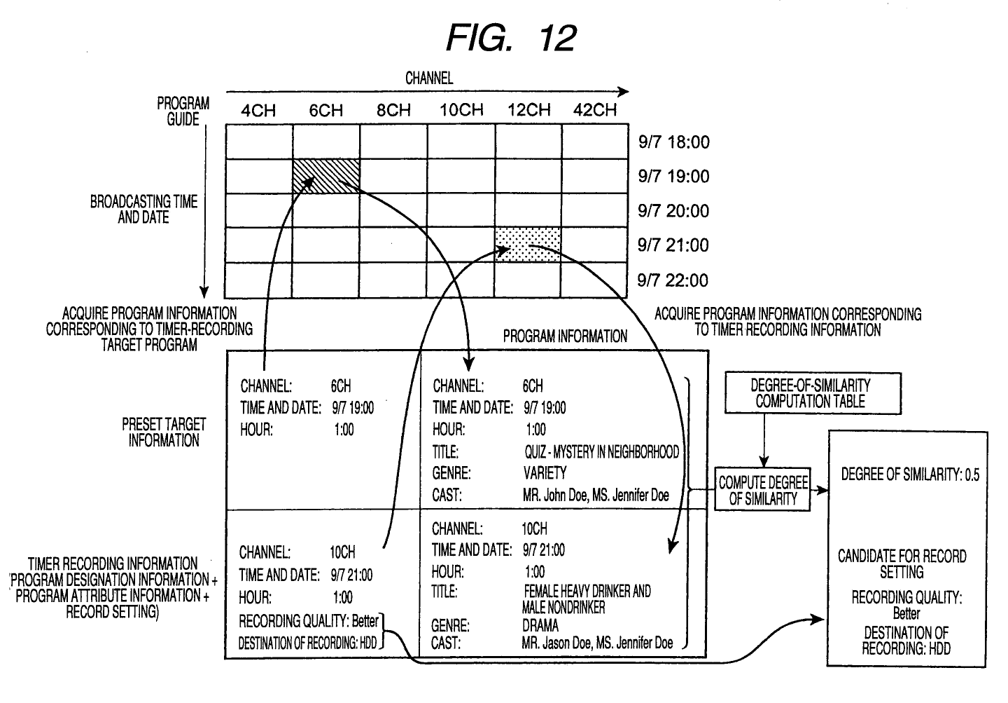

FIG. 12 shows an example extraction of a record setting from the scheduled recording information analogous to the program information about the scheduled recording target program. In relation to the scheduled recording target program, program information corresponding to the procedures up to C2 is acquired. As shown in FIG. 12, in relation to a channel, a starting time, and a recording hour, which correspond to program information about the scheduled recording target program, “6CH,” “one hour from 19:00 on Sep. 7,” a title “Quiz: Mystery in Neighborhood,” a genre “Variety,” and the cast “Mr. John Doe” and “Ms. Jennifer Doe” are acquired. In the meantime, corresponding program designation information and program attribute information are acquired in connection with one of the pieces of scheduled recording information listed in through the procedures C3 to C9. For example, in relation to a record setting including program designation information “6CH” and “One hour from 21:00 on Sep. 7,” recording quality “Better,” and a recording destination “HDD,” there is acquired program attribute information including a title “Female Hard Drinker and Male Nondrinker,” a genre “Drama,” and the cast “Mr. Jason Doe” and “Ms. Jennifer Doe.”

The record setting candidate listing section 103 calculates the degree of similarity between the two pieces of program information. In this case, a coincidence exists between the pieces of program information in terms of some of the cast. Hence, degree-of-similarity 50 is acquired from the table of the rule for calculating the degree of similarity in FIG. 11. Recording quality “Better” and a recording destination “HDD” included in the scheduled recording information are acquired as candidates for record settings.

As a result of performance of processing pertaining to the set of procedures, a record setting associated with scheduled recording information or content information analogous to the specifics of the program information about the scheduled recording target program that is a combination of a program, a channel, a recording start time and date, and a recording time is presented to the user as a candidate for a record setting, so that there can be lessened a burden imposed on the user in setting the scheduled recording operation conforming to specifics of a desired target of the scheduled recording.

A second embodiment of the present invention will now be described hereunder. When scheduled recording information analogous to program information about a scheduled recording target program, content information, and a record setting are searched, the scheduled recording apparatus 1 according to the second embodiment shown in FIG. 2 can include, as targets of search, scheduled recording information, content information, and a record setting stored in another scheduled recording apparatus 2 connected to the network 3 as well as scheduled recording information, content information, and a record setting stored in the apparatus. The scheduled recording apparatus 1 is characterized by having a communication section 17 and the ability to find the other scheduled recording apparatus 2 and acquire necessary information through the network 3.

In order to acquire information about scheduled recording information, content information and a record setting of the other scheduled recording apparatus 2 through the network 3, at least one apparatus must find another apparatus and invoke a public function of the apparatus. UPnP and UPnP AV are used in the present embodiment as a method for implementing the function. UPnP is a protocol of client-server type for finding and controlling a device connected to a network in accordance with a TCP/IP protocol. The scheduled recording apparatus 1 is deemed as a UPnP control point or a client, and the other scheduled recording apparatus 2 is deemed to be a UPnP device or a server. Thus, the scheduled recording apparatus 1 finds the other scheduled recording apparatus 2 and can utilize the function of the other scheduled recording apparatus 2.

By conforming to; for example, ScheduledRecording:1 service and ContentDirectory:2 Service of UPnP AV v2, as control specifications, the record setting candidate listing section 103 can make an access, by way of the communication section 17, to the scheduled recording management section 11, the content management section 13, the program attribute information management section 14, the program designation information management section 15, and the record-presetting information management section 16 of the other scheduled recording apparatus 2. As a result of combined use of the device identifies of the scheduled recording apparatus 1 and 2, scheduled recording information, content information, and a record setting can be handled as being distinguished from information about the apparatus of interest or information about another scheduled recording apparatus.

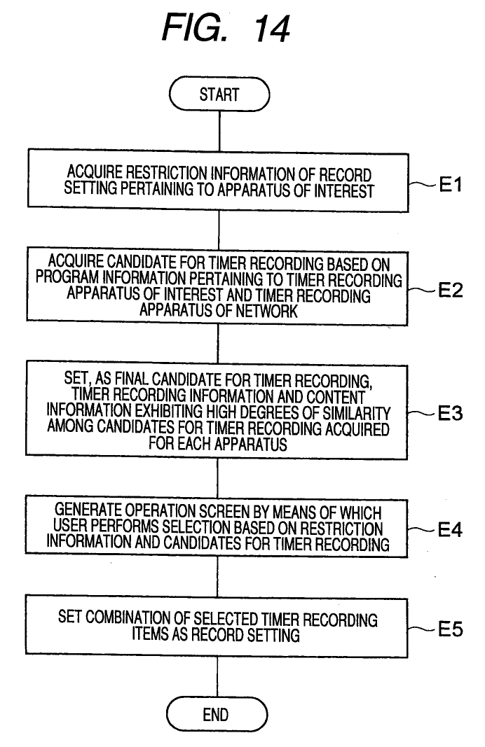

The record setting designation section 102 and the record setting candidate listing section 103 perform processing pertaining to extended record-presetting designation procedures from E1 to E5 as shown in FIG. 14 in place of processing pertaining to S2 shown in FIG. 4; namely, processing pertaining to the record-presetting information designation procedures from B1 to B4 shown in FIG. 6.

In relation to the scheduled recording apparatus 1 that is the apparatus of interest, the record setting designation section 102 performs processing analogous to processing pertaining to B1 shown in FIG. 6, thereby acquiring restriction information about the record setting (E1). The record setting candidate listing section 103 performs in sequence or parallel processing pertaining to B2 shown in FIG. 6; namely, processing pertaining to record-presetting candidate listing procedures from C1 to C15 shown in FIG. 10, in connection with the scheduled recording apparatus 1 that is an apparatus of interest and the scheduled recording apparatus 2 found in the network 3 (E2).

Through the scheduled recording apparatus 1 that is an apparatus of interest and the scheduled recording apparatus 2 that is another apparatus, the record setting candidate listing section 103 sets, as candidates, a record setting exhibiting a high degree of similarity to scheduled recording information and content information; and returns the candidate to the record setting designation section 102 (E3). The record setting designation section 102 accepts a user's selection from the restriction information and the candidates for record settings (E4). The record setting designation section 102 sets as a record setting the combination of scheduled recording items selected by the user (E5).

When scheduled recording information, content information, and a record setting analogous to the program information about the scheduled recording target program are searched, the scheduled recording apparatus 1 of the present embodiment can include, as targets of search, the scheduled recording information, the content information, and the record setting stored in the other scheduled recording apparatus 2 connected to the network 3 as well as the scheduled recording information, the content information, and the record setting stored in the apparatus of interest. As a result of information being widely collected through the network 3, recording can be preset with higher precision.

The embodiments of the present invention have been described thus far. However, the present invention is not limited to the embodiments provided above and susceptible to various modifications.

For example, the scheduled recording apparatus 1 of the present invention may also be configured as being split into two devices; namely, a scheduled recording instruction device for instructing preparation of scheduled recording and a recording-presetting acceptance instruction device for accepting an instruction for preparation of scheduled recording. In this case, the scheduled recording instruction device includes the scheduled recording preparation section 10, the preset target designation section 101, the record setting designation section 102, the record setting candidate listing section 103, and the communication section 17 of the constituent elements of the scheduled recording apparatus 1. The scheduled recording acceptance device includes the scheduled recording management section 11, the recording execution section 12, the content management section 13, the program attribute information management section 14, the program designation information management section 15, the record setting information management section 16, and the communication section 17 of the constituent elements of the scheduled recording apparatus 1.

The scheduled recording acceptance device operates as an UPnP device, and the scheduled recording instruction device operates as an UPnP control point. These devices can establish communication with each other by means of the network 3. One or more scheduled recording acceptance devices and one or more scheduled recording instruction devices may also be present in the single network 3. The scheduled recording instruction device performs processing pertaining to the foregoing record-presetting procedures in relation to one of the communicable scheduled recording acceptance devices in the network 3.

Specifically, the communication section 17 of the scheduled recording instruction device finds a communication section 17 of a scheduled recording acceptance device in the network through use of a device discovery function of the UPnP and acquires an identifier of the scheduled recording acceptance device. The scheduled recording instruction device transmits an operation request from respective sections of the scheduled recording instruction device to the scheduled recording acceptance device through the communication section in accordance with the identifier of the scheduled recording acceptance device; and receives a response, thereby performing processing pertaining to the record-presetting procedures.

When the record setting for scheduled recording is moved among a plurality of devices, it goes without saying that program information about a scheduled recording target program should remain identical between a source device and a destination device, and possibly-appropriate values are desirably set even in connection with a record setting. However, specifics of a record setting of the recorder greatly change from one manufacturer to another or from one device to another in terms of a type and indications of values, and selecting and setting appropriate values is not easy. However, in this configuration, a record setting or a candidate for record setting associated with scheduled recording information or content information analogous to program information about a scheduled recording target program is transmitted or received through the network 3. Hence, even when the type of a record setting or indications of values may change from one device to another, a candidate for record setting conforming to specifics of a scheduled recording target program can be presented to the user in a more appropriate manner.

In the second embodiment, the record setting candidate listing section 103 is assumed to list respective pieces of scheduled recording information and content information and compute the degree of similarity. Sharing of processing yields an advantage of the ability to cause the combination of the record setting candidate listing section 103 and the communication section 17 and respective combinations of the scheduled recording management section 11, the program attribute information management section 14, the program designation information management section 15, the record setting information management section 16, the content management section 13, and the communication section 17 to fall within the range of standard protocols of UPnP and UPnP AV.

In the meantime, the scheduled recording management section 11 and the content management section 13 are arranged so as to accept meta information that serves as an object of computation of the degree of similarity; to compute the degrees of similarity; and to return results of computation. Thus, amounts of computation and communication performed by the record setting candidate listing section 103 can be diminished. Further, the scheduled recording management section 11 and the content management section 13 compute the degrees of similarity in advance in connection with predicted preset target contents or partial information about preset target contents, whereby burdens for computation of respective degrees of similarity can be lessened.

In the present invention, if possible candidates for record settings may also be determined by performing caching operation at an UI area. In short, the record setting candidate listing section 103 retains a pair consisting of program information about the past scheduled recording target program or a part thereof and a record setting taken as a candidate. When the degree of similarity between the pair and program information about a new scheduled recording target program is sufficiently high, corresponding scheduled recording information may also be set as a candidate for selection without acquiring analogous scheduled recording information and content information from the scheduled recording management section 11 and other sections.

Alternatively, in the present invention, when determined that a candidate having a sufficient degree of similarity is acquired during search of a record setting corresponding to program information about a scheduled recording target program or when determined that a sufficient number of candidates are acquired during search, the record setting candidate listing section 103 may also terminate subsequent searching operation. As a result, there can be avoided undermining of the significance of display of candidates, which would otherwise be caused when an excessively-large number of candidates for record settings are set in relation to values that can be set for scheduled recording items.

As described above in detail, according to the present invention, there is provided a scheduled recording apparatus and a method for setting a scheduled recording, in which, when setting the scheduled recording of a scheduled recording target program, the user can set a record setting based on specifics of the program without involvement of laborious operation for the record setting.

What is claimed is:

1. A scheduled recording apparatus comprising:
a recording unit configured to record a video in accordance with a preset record setting;
a storage unit configured to store content information and record settings, the content information indicating contents recorded in the past by the recording unit, the record settings being set for each of the recorded contents;
a target program designation unit configured to designate a scheduled recording target program to be subjected to a scheduled recording;
a candidate listing unit that, when a degree of similarity between program information pertaining to the scheduled recording target program designated by the target program designation unit and content information pertaining to the recorded contents is equal to or larger than a threshold value, extracts from the storage unit the record settings as candidates of a target record setting to be used in recording the scheduled recording target program; and
a scheduled recording designation unit that selects the target record setting from among the candidates extracted by the candidate listing unit.

2. The apparatus according to claim 1, wherein each of the program information and the content information are at least one of broadcast channels, genres, broadcasting days, broadcasting times, and titles of programs of the scheduled recording target program and the recorded contents.

3. The apparatus according to claim 1, wherein the storage unit is installed in the apparatus, and
wherein the candidate listing unit extracts the record settings stored in the storage unit as the candidates of the target record setting.

4. The apparatus according to claim 1 further comprising a communication unit that transmits the candidates extracted by the candidate listing unit to an external apparatus that is connected to the apparatus via a network.

5. A method for setting a scheduled recording in a scheduled recording apparatus, the method comprising:
recording a video in accordance with a preset record setting;
storing content information and record settings, the content information indicating contents recorded in the past by the recording unit, the record settings being set for each of the recorded contents;
designating a scheduled recording target program to be subjected to a scheduled recording;
extracting, when a degree of similarity between program information pertaining to the designated scheduled recording target program and content information pertaining to the recorded contents is equal to or larger than a threshold value, from the stored record settings as candidates of a target record setting to be used in recording the scheduled recording target program; and
selecting the target record setting from among the extracted candidates.

6. The method according to claim 5, wherein each of the program information and the content information are at least one of broadcast channels, genres, broadcasting days, broadcasting times, and titles of programs of the scheduled recording target program and the recorded contents.

7. The method according to claim 5, wherein the candidates are extracted from among the record settings stored in a storage unit that is installed in the scheduled recording apparatus.

8. The method according to claim 5, wherein the candidates are extracted from among the record settings stored in a storage unit that is installed in an external apparatus that is connected to the scheduled recording apparatus via a network.

9. The method according to claim 5 further comprising transmitting the candidates extracted by the candidate listing unit to an external apparatus that is connected to the scheduled recording apparatus via a network.
